(19) United States
(12) Patent Application Publication
(10) Pub. No.: US 2020/0356220 A1
(43) Pub. Date: Nov. 12, 2020

(54) OFFLINE CUSTOM CODE LIST ORDERING

(71) Applicant: SAP SE, Walldorf (DE)

(72) Inventors: Thomas Biesemann, Bruchsal (DE); Tim Kornmann, Weisloch (DE)

(21) Appl. No.: 16/408,706

(22) Filed: May 10, 2019

(51) Int. Cl. G06F 3/0482; H04L 12/24; G06F 17/24

(52) U.S. Cl. CPC G06F 3/0482; G06Q 30/04; G06F 17/243; H04L 41/22

(57) ABSTRACT

Briefly, embodiments of a system, method, and article for synchronizing local meta data for an application, stored in a memory of a user device, with administrator meta data for the application, stored in a server, while the user device is in a first mode connected to the server are disclosed. The administrator meta data may indicate a list of selectable codes for a form document in a drop-down box reordered by an administrator from a default order. An application may be executed by the user device, while the user device is in a second mode disconnected from the server, to present the form document with the reordered list of selectable codes in the drop-down box. A user input may be received where the user input comprises a selection of at least one of the selectable codes in the drop-down box.

### BACKGROUND

A representative may generate certain forms or documents, such as an invoice or order, for example, in order to complete a transaction for goods or services. For example, a representative may generate an invoice which indicates certain information such as a name and address of a customer, contact information for the customer, a country from which certain goods or services are sourced, a country to which the goods or services are to be delivered, a requested delivery date, a unit of measurement such as pounds or kilograms, or a unit of currency by which the goods or services are to be paid, such as in U.S. Dollars or Euros. Certain information may be often be commonly entered in different forms or documents, such as U.S. Dollars as a unit of currency by a representative in a country who often sells goods or services to companies in the United States.

Some electronic documents such as fauns include drop-down boxes showing various options for data entry fields on a form. For example, if a country code is required for a form, there may be a drop-down box with a list of available country codes. A user may select the drop-down box and the available options within the drop-down box may be displayed. A user may select the appropriate country code selection, such as “United States” if an electronic form is being generated for a transaction to a customer based in the United States, for example. In some electronic forms, the available selectable options within a drop-down box are displayed within a particular default order. For example, the available selectable options may be presented in alphabetic order where “Afghanistan” is listed first, followed by “Albania,” and “United States” is listed more than 150 spots lower on the list in the drop-down box. However, if a representative is generating an electronic form for the sale to the customer in the United States, the representative may have to manually scroll down the list to find the “United States” entry, a process which may be cumbersome for the representative. If an electronic form has numerous drop-down boxes for different data entry fields, having to manually scroll through each drop-down box to find the appropriate selection may be inefficient and may adversely affect worker productivity.

Some implementations may list selectable options within a default order which lists options which are more common higher in the list of a drop-down box. However, in these implementations, the default order is typically fixed, and the representative may still have to scroll through various drop-down boxes if the representative frequently generates fauns for transactions to certain repeat customers in certain areas of the world. For example, if the representative is responsible for transactions to certain Eastern European countries, such as Hungary or Poland, even if larger countries such as United States or Germany are listed near the top of selectable options on a drop-down list, the representative may still often have to exert effort to scroll down to find a country code selection for Hungary or Poland, for example.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 illustrates an embodiment of a system for communicating an electronic document.

FIG. 2 illustrates an electronic document accordance to an embodiment.

FIG. 3 illustrates a drop-down box before and after reordering of one or more codes or items presented therein according to an embodiment.

FIG. 4 is an embodiment of a flowchart of a process for an administrator to modify an order of codes in one or more drop-down boxes of an electronic document.

FIG. 5 is an embodiment of a flowchart of a process for synchronizing information between a user device and a server.

FIG. 6 illustrates a user device according to an embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

One or more embodiments as discussed herein are directed to generating and displaying a custom list of items or codes in a field of an electronic form document. An electronic form document is referred to herein as an “electronic form document” or a “form document.” For example, an electronic form document, such as a sales order or invoice, may include one or more fields where a user such as a salesperson may enter certain information relating to a sale of goods or services to a customer. For example, the electronic form document may include an address of a customer, contact information for the customer, and certain codes, such as a country from which certain goods or services are sourced, a country to which the goods or services are to be delivered, a requested delivery date, a unit of measurement such as pounds or kilograms, or a unit of currency by which the goods or services are to be paid, such as in U.S. Dollars or Euros, to name just a few example among many. A “code,” as used herein refers to a selectable item within a list of an enumeration of values. Certain information may be often be entered in different forms, such as U.S. Dollars as a currency by a salesperson who often sells goods or services to companies in the United States. For example, a code may be utilized to represent various currencies, such as “USD” or “$” for United States currency; “Euros” or “€” for European currency; “Yen,” “JPY,” or “JPY ¥” for Japanese currency; and “Yuan” or “CNY” or “CNY ¥” for Chinese currency, to name just a few examples among many examples of currencies.

Country codes may also be utilized, such as “US” or “USA” for the United States of America; “DE” or “DEU” for Germany; “FR” or “FRA” for France; “CN” or “CHN” for China; and “JP” or “JPN” for Japan. It should be appreciated that various country codes may be utilized, such as those which are two, three, or more characters, for example. In some embodiments, a code may comprise a full spelling of a country name as opposed to short abbreviation, for example. Codes may additionally be utilized to indicate units of measurement, such as “lb” for pounds, “kg” for kilograms, “oz” for ounces, “fl. oz.” for fluid ounces, “ft” for feet, or “m” for meters, to name just a few examples among many. It should be appreciated that there are many different codes which may be utilized within an electronic form document as discussed herein and only a few types are described solely for the sake of illustration. However, the teachings herein are applicable to embodiments utilizing various other types of codes, for example.

In accordance with an embodiment, an electronic form document may include various portions in which a user may provide information. For example, a user may manually provide information for a portion of the electronic form document by utilizing a user input device, such as a keyboard to type in certain information, such as a name or address of a customer. After a user has provided information for the electronic form document, a completed or partially completed version of the document may be saved or stored, for example, such as locally on the user's computing device, such as computer, laptop, smart phone, tablet, or other computing device, for example, and/or may be transmitted or otherwise provided to a network device, such as a server. For example, the server may comprise a remote server and/or a cloud-based server in one or more implementations. A completed or partially completed version of an electronic form document may comprise or may otherwise be utilized to generate an invoice and/or order list, for example.

In some embodiments, a user may provide a relatively large amount of information in order to complete or partially complete filling out the electronic form document. In order to assist a user in providing information to complete the electronic form document, for example, certain items of selectable information may be presented to a user. For example, a drop-down box may be presented for a portion of the electronic form document where the user can select from among various codes or items presented within the drop-down box. For example, if there is a portion of the electronic form document where a user is to indicate a country in which a customer is located, such as for payment and/or delivery, a drop-down box may present various country codes so that a user may select from among the country codes instead of having to manually type in the country code. Moreover, by presenting the user with selectable country codes, incidence of errors may be reduced as opposed to if the user were to manually mistype a country code, such as by manually typing a country code which is incorrect and/or non-existent.

A “drop-down box” or list, as used herein, refers to a graphical control element which allows a user to choose a value from a list. In one example, if a drop-down box is inactive, the drop-down box may display a single value. However, if activated, such as by being selected or clicked on, the drop-down box may display or “drop down” a list of enumerated values, from which the user may select a value. If the user selects a new value, the drop-down box may revert to an inactive state, displaying the selected value.

In one implementation, various drop-down boxes may include listings of enumerated values such as codes, where the codes are presented in a default order. In an example, among country codes, the country codes may be listed in an alphabetic order as a default order. Alternatively, the country codes may be listed in some other order as a default, such as with the United States being listed first and/or other relatively large countries with which business has been conducted previously also listed near a top of the drop-down box, such as China or Japan. However, if the user is a representative who is primarily responsible for orders to Central Europe or Eastern Europe, presenting a drop-down box with the United States, China, and/or Japan listed near a top of the codes in the drop-down box may be inefficient and/or cumbersome as the user may have to scroll past codes presented near the top to reach other codes with which the user is more likely to deal, such as Germany, Poland, or Hungary, for example.

Accordingly, one or more embodiments are presented herein which enable an administrator, such as a human with administration rights or privileges, to change an order in which codes or other items are listed in one or more drop-down boxes. For example, an administrator may access an electronic form document and may reorder a listing of codes or items in one or more drop-down boxes from a default listing or from a prior ordering of the codes. If an administrator reorders a listing of codes for a particular drop-down box, meta data indicative of this reordering may be generated which is indicative of this change and may be stored in a network server, such as a cloud-based server. For example, such meta data may be stored in the same cloud server where a global version of the electronic form document is stored. In one example, an administrator may reorder the items in a drop-down box while the administrator has a network connection with the server. For example, if the administrator has an active network connection with a server where the electronic form document is stored, the administrator may be considered to be operating within an “online mode” and a reordering of codes in a drop-down box may be stored as meta data in the server at the time of the reordering or shortly thereafter. Alternatively, an administrator may access a previously downloaded local version of the electronic form document, for example, which is stored on a computing device utilized by the administrator, even if the administrator is operating within an “offline mode” or otherwise lacks an active connection with a server where a global version of the electronic form document. In such an example, for example, the administrator's computing device may generate and store meta data indicative of a reordering of codes or items in a drop-down box on the administrator's local computing device, for example, and the meta data indicative of the reordering may thereafter be uploaded to the server and associated with the global version of the electronic form document.

There may be a plurality of users with access to a global version of an electronic form document, such as users who may regularly utilize the electronic form document. However, in accordance with an embodiment, only a user with administrative rights or privileges may have an ability to reorder codes or items in one or more drop-down boxes of the electronic form document. If an administrator, for example, reorders codes or items in one or more drop-down boxes of an electronic form document, meta data corresponding to the reordering may be uploaded to or otherwise stored in a server such as where a global version of the electronic form document is stored. Such meta data may occasionally be synchronized with user devices for various users who have local versions of the electronic form document stored on their local devices. For example, certain users may be associated with the global electronic device and meta data on the server for the global version of the electronic form document may periodically be synchronized with meta data for local versions of the electronic form document as stored on local computing devices for the various associated users.

A user may have an ability to toggle or select between an online mode and an offline line to connect to the server and/or disconnect from the server, for example. If a user toggles to an online mode, meta data stored on the server may be synchronized with local meta data stored the user's computing device so that any reordering of codes or items in a drop-down box as made by an administrator may be transmitted to the user's local computing device so that the reordered code list of an electronic form document may presented to the user, for example. A user may select to remain in offline mode, for example, if the user is trying to preserve battery power or reduce network usage, such as where Internet coverage is spotty or otherwise weak, for example. The user may select to switch or toggle to online mode if, for example, the user has a strong Internet connection. In some embodiments, a decision to toggle between online and offline modes may be made without a user input. For example, the user's device may periodically toggle from offline mode to online mode at periodic intervals of time, such as every 15 or 30 minutes. In some other embodiments, the user's device may switch or toggle from offline mode to online mode if, for example, the user's device is receiving a Wi-Fi signal such that the user's potentially limited network data is preserved, for example.

While a user device is in offline mode, the user may submit information to the electronic form document, such as via drop-down boxes, to generate various invoices or orders, for example, even when the user's device lacks a network connection to the server. In such an example embodiment, various invoices or product/service orders or other completed electronic form documents may be generated and stored locally on the user's device while in the offline mode and may subsequently be transmitted to the server as a later time, such as the next time that the user is in online mode.

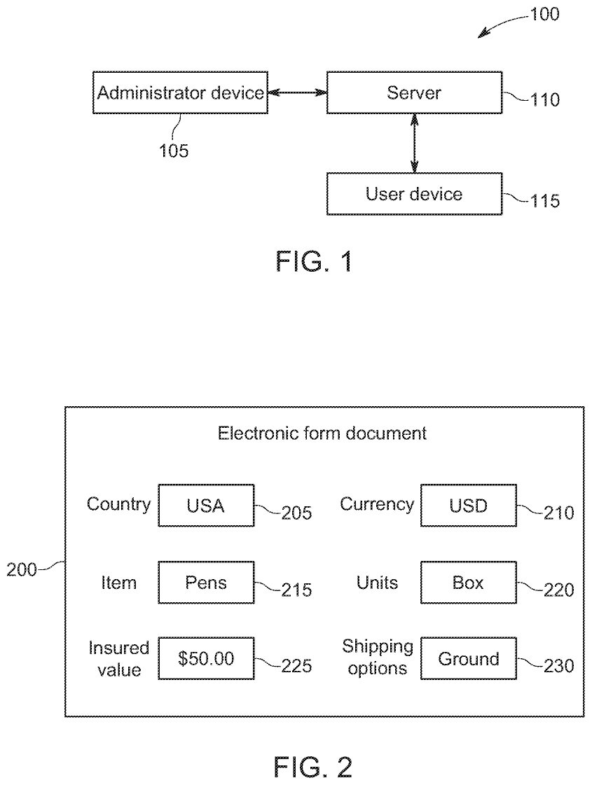

FIG. 1 illustrates an embodiment 100 of a system for communicating an electronic form document. For example, the electronic form document may include several portions where a user may enter information and the electronic form document may be utilized to generate an invoice or sales order. The electronic form document may include one or more drop-down boxes where a user may select from an ordered list of items to fill into a field on the electronic form document, for example. Embodiment 100 may include an administrator device 105, a server 110, and a user device 115. Administrator device 105 and user device 115 may comprise a computing device such as a desktop or laptop computer, smart phone, or tablet, to name just a few examples among many, for example. Although only one administrator device 105, one server 110, and one user device 115 are illustrated in embodiment 100, it should be appreciated that more than one of any of these items may be utilized in some implementations. Server 110 may comprise a cloud-based server or cloud-based servers, for example. Server 110 may store a global electronic form document and meta data associated with the global electronic form document, such as meta data to indicate an order in which one or more codes or items in one or more drop-down boxes are to be displayed or otherwise presented. An administrator, such as a human with administrative rights or privileges, may utilize administrator device 105 to access the global electronic form document stored in server 110 and may reorder a list of codes or items in the one or more drop-down boxes of electronic form document, for example. For example, an administrator may access the electronic form document in server 110 via an on-line mode to reorder the codes or items in the one or more drop-down boxes. After reordering the codes or items in the one or more drop-down boxes of the electronic form document, associated meta data indicative of the reordering may be stored in server 110.

User device 115 may include a memory to store a local version of the electronic form document and corresponding meta data. Meta data stored in server 110 may be synchronized with the meta data stored locally in a memory of user device 115 so that, for example, a reordering of codes or items in one or more drop-down boxes made by an administrator is reflected in a local version of the electronic faun document stored in the memory of user device 115. For example, user device 115 may toggle between an offline and an online mode and the synchronization may be performed during the online mode. User device 115 may toggle from offline mode to online mode in response to a user input or may toggle periodically or when the user device has access to Wi-Fi network access, to name just a few examples among many. In some implementations, user device 115 may transmit a request for the synchronization while in the online mode. In other implementations, for example, meta data stored in the server 110 may be pushed to the user device 115 so that the synchronization is performed without the user device 115 requesting the synchronization. In one particular embodiment, meta data for a local version of an electronic form document stored in user device 115 may be deleted and replaced with meta data stored in server 110 during synchronization, for example.

FIG. 2 illustrates an electronic form document 200 accordance to an embodiment. Electronic form document 200 may include various portions or fields into which a user may submit or otherwise provide information. For example, as shown, electronic form document 200 includes various drop-down boxes. As illustrated, electronic form document 200 may include a first drop-down box 205 from which a user may select a country code such USA for United States, FRA for France, DEU for Germany, and so forth. A second drop-down box 210 may be utilized by a user to a currency code such as USD for U.S. Dollars, EUR for Euros, or JPY for Japanese Yen, to name just a few examples. A third drop-down box 215 may be utilized by a user to select a code for an item being sold or transacted, such as pens, paper, desks, chairs, or any other items for sale, for example. In some embodiments, a drop-down box for a service may be included instead of or in addition to the third drop-down box 215 for the item being sold or transacted, for example. A fourth drop-down box 220 may be utilized by a user to select a unit by which the item is being sold, such as box, case, pound, number, etc. A fifth drop-down box 225 may be utilized by a user to select an insured value for the item being sold or transacted, such as $50.00, $100.00, or $500.00, to name just a few examples among many. A sixth drop-down box 230 may be utilized to select a shipping option such as ground shipping or air mail, for example. Although only six drop-down boxes are shown in FIG. 2, it should be appreciated that more, or fewer, drop-down boxes may be included in an electronic form document 200 in accordance with some embodiments. Moreover, an electronic form document 200 may also include various additional portions where a user may manually enter certain information, such as without use of a drop-down box. For example, in some implementations, information such as a name and/or address of a client may comprise information which may be manually entered or otherwise provided by a user instead of being selected via a use of a drop-down box.

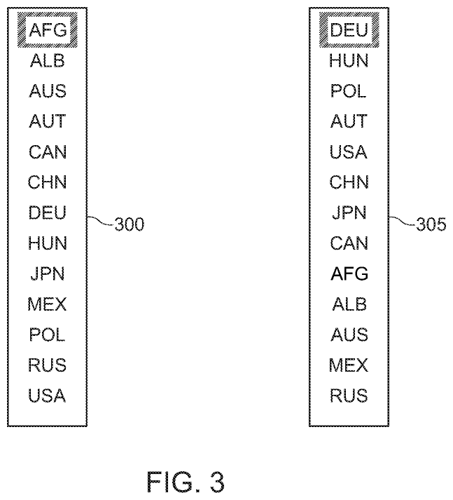

FIG. 3 illustrates a drop-down box before and after reordering of one or more codes or items presented therein according to an embodiment. For example, an initial drop-down box 300 may include a list of country codes which are presented in an alphabetic order and reordered drop-down box 305 may include the list of country codes which may be reordered by an administrator. For example, initial drop-down box 300 may include a list of country codes ordered starting with codes for Afghanistan (AFG), Albania (ALB), Australia (AUS), Austria (AUT), Canada (CAN), China (CHN), Germany (DEU), Hungary (HUN), Japan (JPN), Mexico (MEX), Poland (POL), Russia (RUS), and the United States (USA). A total of 13 country codes are display in initial drop-down box 300 for the sake of brevity. However, it should be appreciated that there are more than 190 countries in the world and that in some embodiments, country codes for all 190+ countries may be listed in initial drop-down box 300.

An administrator may customize or modify an order in which country codes are displayed or otherwise presented to generate a reordered drop-down box 305. For example, if the sale of certain goods or services is illegal to be made to someone in Afghanistan (AFG), the country code for Afghanistan (AFG) may therefore be deleted from reordered drop-down box 305. Similarly, if a country is omitted from initial drop-down box 300, such as by error or otherwise, a country code for the omitted country may be added by an administrator to reordered drop-down box 305.

An administrator may provide one or more user inputs to modify an order of codes in reordered drop-down box 305. For example, the administrator may manually select and drag a particular country code such as for Germany (DEU) from the middle of initial drop-down box 300 to the top of the list, so that the country code for Germany (DEU) is at the top of reordered drop-down box 305. Similarly, an administrator may manually type or enter information indicative of a reordering of the country codes. For example, as shown, reordered drop-down box 305 may include the list of country codes ordered starting with Germany (DEU), Hungary (HUN), Poland (POL), Austria (AUT), the United States (USA), China (CHN), Japan (JPN), Canada (CAN), Afghanistan (AFG), Albania (ALB), Australia (AUS), Mexico (MEX), and Russia (RUS). If a user, such as a salesperson, is primarily responsible for sales of goods or services to countries in Eastern Europe, it may be advantage or beneficial to reorder the country codes in this manner, for example.

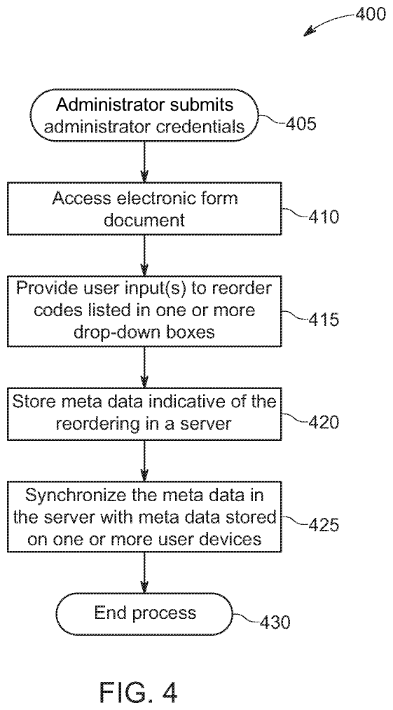

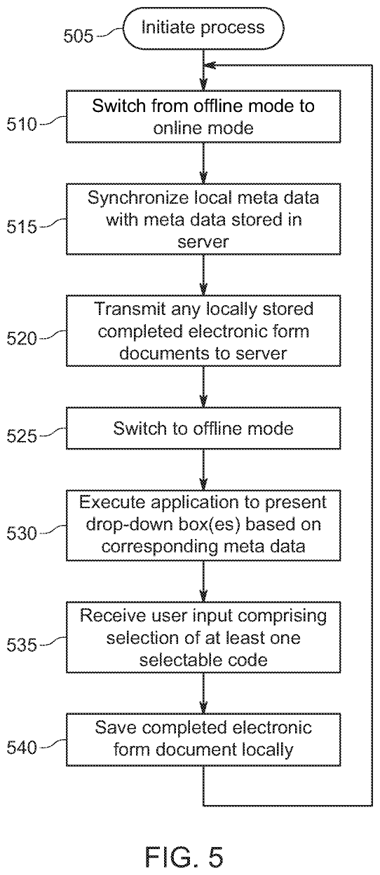

If an administrator reorders the country codes, meta data indicative of the reordering may be generated and stored in a server, for example. In accordance with an embodiment, such meta data may be synchronized with one or more user devices on which local versions of the electronic form document are stored so that local versions include the reordered country codes in accordance with reordered drop-down box 305, such as is discussed below with respect to FIGS. 4 and 5.

FIG. 4 is an embodiment 400 of a flowchart of a process for an administrator to modify an order of codes in one or more drop-down boxes of an electronic form document. Embodiments in accordance with claimed subject matter may include all of, less than, or more than blocks 405 through 430. Also, the order of blocks 405 through 430 is merely an example order. At operation 405, an administrator may submit administrator credentials, such as by logging in with an administrator login/password. At operation 410, the administrator may access an electronic form document having one or more drop-down boxes. At operation 415, the administrator may provide one or more user inputs to reorder codes listed in one or more drop-down boxes to reorder the codes from an initial order, such as a default order, to a customized order, for example. At operation 420, meta data indicative of the reordering may be stored in one or more servers, such as within one or more cloud servers. At operation 425, the meta data indicative of the reordering may be synchronized with meta data stored in one or more user devices so that if the one or more user devices present a local version of the electronic form document, the reordering of the codes within one or more drop-down boxes may be presented to a user. At operation 430, processing may pause or end until the administrator chooses to make a further modification to one or more drop down boxes of the electronic form document.

FIG. 5 is an embodiment 500 of a flowchart of a process for synchronizing information between a user device and a server. Embodiments in accordance with claimed subject matter may include all of, less than, or more than blocks 505 through 5440. Also, the order of blocks 505 through 540 is merely an example order. At operation 505, processing may be initiated. At operation 510, a user device may switch, toggle, or transition from an offline mode to an online mode. For example, a user may provide a user input to transition the user device from the offline mode to the online mode. In some embodiments, the user device may periodically transition to online mode without a user input, such as every 15 or 30 minutes, or if an available Wi-Fi connection has been detected, for example. At operation 515, local meta data stored on the user device may be synchronized with meta data stored on a server. Similarly, any electronic form documents which were completed while the user device was in the offline mode may be transmitted to the server at operation 520. At operation 525, the user device may switch to offline mode from online mode. At operation 530, an application may be executed by the user device to present an electronic form document with one or more drop-down boxes having codes ordered or reordered based on information in corresponding meta data. At operation 535, a user input may be received comprising a user selection of at least one selectable code in at least one drop-down box, e.g., as a user completes an electronic form document by submitting or otherwise filling in certain portions of the electronic form document. At operation 540, the user's completed or at least partially completed electronic form document may be saved locally, such as in a memory device of the user device. Processing may subsequently proceed to operation 510.

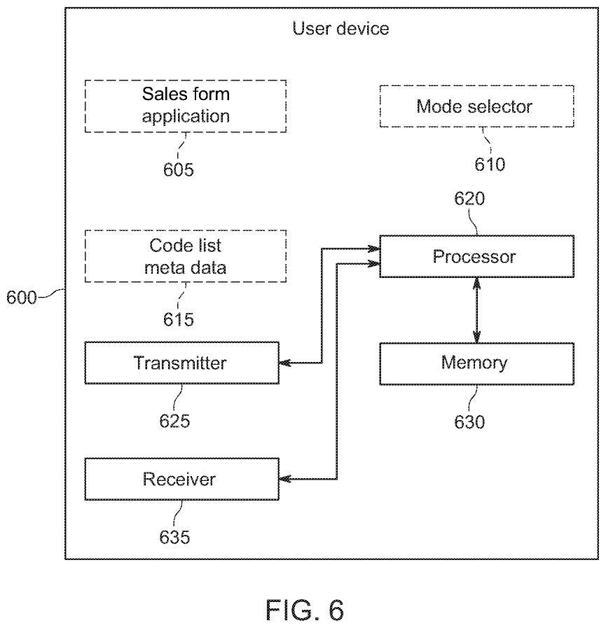

FIG. 6 illustrates a user device 600 according to an embodiment. As illustrated, user device 600 may include a sales form application 605, a mode selector 610, code list meta data 615, a processor 620, a transmitter 625, a memory 630, and a receiver 635, to name just a few example components among many possibilities. For example, sales form application 605 may comprise an application program which may present an electronic form document having one or more drop-down boxes to a user. A mode selector 610 may be utilized to toggle or switch the user device 600 between online and offline modes. For example, mode selector 610 may switch between online and offline modes based, at least partially, on a user input. In some embodiments, as discussed above, the user device may periodically transition to online mode without a user input, such as every 15 or 30 minutes, or if an available Wi-Fi connection has been detected, for example. Code list meta data 615 may be associated with sales form application 605 and may indicate an order in which codes or items in one or more drop-down boxes are to be displayed or otherwise presented within an electronic form document, for example.

Processor 620 may, for example, execute program code or instructions stored in memory 630 to execute sales form application 605, implement mode selector 610, and associate code list meta data 615 with sales form application 605, for example. Processor 620 may process signals received by receiver 635, such as signals to synchronize code list meta data stored in a server with code list meta data 615, for example. A completed or partially completed electronic form document with one or more user selections, such as received via one or more drop-down boxes, may be stored in memory 630. Transmitter 625 may transmit one or more signals to a server while in an online mode, for example, to request a synchronization of code list meta data and/or to transmit or upload a completed or partially completed electronic form document to a server.

Some portions of the detailed description are presented herein in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

It should be understood that for ease of description, a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include now known, and/or to be later developed arrangements, derivatives, and/or improvements, including, for example, past, present and/or future mass storage, such as network attached storage (NAS), a storage area network (SAN), and/or other forms of computing and/or device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as computing and/or communication protocols (e.g., network protocols), may interoperate within a larger network. In this context, the term sub-network and/or similar terms, if used, for example, with respect to a network, refers to the network and/or a part thereof. Sub-networks may also comprise links, such as physical links, connecting and/or coupling nodes, such as to be capable to transmit signal packets and/or frames between devices of particular nodes, including wired links, wireless links, or combinations thereof. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs. In this context, a private network refers to a particular, limited set of network devices able to communicate with other network devices in the particular, limited set, such as via signal packet and/or frame transmissions, for example, without a need for re-routing and/or redirecting transmissions. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate nodes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but devices outside the private network may not necessarily be able to direct inbound network communications to devices included in the private network.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method, comprising:
synchronizing local meta data for an application, stored in a memory of a user device, with administrator meta data for the application, stored in a server, while the user device is in a first mode connected to the server, wherein the administrator meta data indicates a list of selectable codes for a form document in a drop-down box reordered by an administrator from a default order;
executing the application, by the user device while the user device is in a second mode disconnected from the server, to present the form document with the reordered list of selectable codes in the drop-down box; and
receiving a user input comprising a selection of at least one of the selectable codes in the drop-down box.

2. The method of claim 1, wherein the list of selectable codes comprises an enumeration of values.

3. The method of claim 1, further comprising switching between the first and second modes based, at least in part, on the user input further comprising a selection to switch modes.

4. The method of claim 1, further comprising switching between the first and second modes based, at least in part, on network availability.

5. The method of claim 1, wherein the selectable codes comprise one or more of country codes or units of measurement.

6. The method of claim 1, further comprising saving a completed form document at least partially in response to receiving the user input.

7. The method of claim 6, further comprising uploading the completed form document to the server at least partially in response to switching from the second mode to the first mode.

8. A user device, comprising:
a receiver to receive one or more electronic signals from a server;
a transmitter to transmit the one or more electronic signals to the server;
a memory;
a processor to:
process administrator meta data received from the server for an application while the user device is in a first mode connected to the server to transmit and receive the one or more electronic signals with the server, wherein the administrator meta data indicates a list of selectable codes for a form document in a drop-down box reordered by an administrator from a default order;
executing the application, while the user device is in a second mode disconnected from the server, to present the form document with the reordered list of selectable codes in the drop-down box; and
receiving a user input comprising a selection of at least one of the selectable codes in the drop-down box.

9. The user device of claim 8, wherein the list of selectable codes comprises an enumeration of values.

10. The user device of claim 8, wherein the processor is to switch between the first and second modes based, at least in part, on the user input further comprising a selection to switch modes.

11. The user device of claim 8, wherein the processor is to switch between the first and second modes based, at least in part, on network availability.

12. The user device of claim 8, wherein the selectable codes comprise one or more of country codes or units of measurement.

13. The user device of claim 8, wherein the processor is to save a completed form document at least partially in response to receiving the user input.

14. The user device of claim 13, further comprising uploading the completed form document to the server at least partially in response to switching from the second mode to the first mode.

15. An article, comprising:
a non-transitory storage medium comprising machine-readable instructions executable by a special purpose apparatus to:
synchronize local meta data for an application, stored in a memory of a user device, with administrator meta data for the application, stored in a server, while the user device is in a first mode connected to the server, wherein the administrator meta data indicates a list of selectable codes for a form document in a drop-down box reordered by an administrator from a default order;
execute the application, by the user device while the user device is in a second mode disconnected from the server, to present the form document with the reordered list of selectable codes in the drop-down box; and
process a received user input comprising a selection of at least one of the selectable codes in the drop-down box.

16. The article of claim 15, wherein the machine-readable instructions are further executable by the special purpose apparatus to switch between the first and second modes based, at least in part, on the user input further comprising a selection to switch modes.

17. The article of claim 15, wherein the machine-readable instructions are further executable by the special purpose apparatus to switch between the first and second modes based, at least in part, on network availability.

18. The article of claim 15, wherein the machine-readable instructions are further executable by the special purpose apparatus to save a completed form document at least partially in response to receiving the user input.

19. The article of claim 18, wherein the machine-readable instructions are further executable by the special purpose apparatus to upload the completed form document to the server at least partially in response to switching from the second mode to the first mode.

20. The article of claim 15, wherein the list of selectable codes comprises an enumeration of values.
